(19) United States
(12) Patent Application Publication
(10) Pub. No.: US 2025/0266618 A1
(43) Pub. Date: Aug. 21, 2025

(54) COIL COMPONENT AND COMMUNICATION DEVICE HAVING THE SAME

(71) Applicant: TDK Corporation, Tokyo (JP)

(72) Inventors: Shoma KAJIKIYA, Tokyo (JP); Makoto HIRAKI, Tokyo (JP); Toshio TOMONARI, Tokyo (JP)

(21) Appl. No.: 19/057,131

(22) Filed: Feb. 19, 2025

(30) Foreign Application Priority Data
Feb. 21, 2024 (JP) 2024-024451

(51) Int. Cl. H01Q 7/00; H04B 5/26

(52) U.S. Cl. CPC H01Q 7/00; H04B 5/26

(57) ABSTRACT

Disclosed herein is a coil component that includes a resin layer including insulating inorganic fillers and a binder resin, and a coil conductor embedded at least partially in the resin layer and wound in a plurality of turns. The resin layer includes a first area that overlaps the coil conductor as viewed in a coil axis direction and a second area positioned between adjacent turns of the coil conductor. The filling rate of the inorganic fillers in the resin layer is higher in the first area than in the second area.

### CROSS-REFERENCE TO RELATED APPLICATION

This application claims the benefit of Japanese Patent Application No. 2024-024451, filed on Feb. 21, 2024, the entire disclosure of which is incorporated by reference herein.

### BACKGROUND

The present disclosure relates to a coil component and a communication device having the same.

International Publication WO 2016/199633 discloses a coil module including a coil pattern provided on the surface of a coil substrate and an adhesive layer provided on the coil substrate surface so as to embed therein the coil pattern. The adhesive layer described in International Publication WO 2016/199633 contains thermally conductive particles and adhesive resin.

In the invention disclosed in International Publication WO 2016/199633, the thermally conductive particles contained in the adhesive layer are dispersed uniformly, making it difficult to satisfy both electrical and physical characteristics.

### SUMMARY

A coil component according to an embodiment of the present disclosure includes: a resin layer containing insulating inorganic fillers and binder resin; and a coil conductor embedded at least partially in the resin layer and wound in a plurality of turns. The resin layer includes a first area that overlaps the coil conductor as viewed in the coil axis direction and a second area positioned between adjacent turns of the coil conductor, and the filling rate of the inorganic fillers in the resin layer is higher in the first area than in the second area.

### BRIEF DESCRIPTION OF THE DRAWINGS

The above features and advantages of the present disclosure will be more apparent from the following description of some embodiments taken in conjunction with the accompanying drawings, in which:

FIG. 1 is a schematic plan view illustrating the outer appearance of a coil component 100 according to an embodiment of the present disclosure;

FIG. 2 is a schematic partial cross-sectional view of the coil component 100;

FIG. 3 is a schematic diagram for explaining capacitors C1 and C2 formed by adjacent turns;

FIG. 4 is a schematic view for explaining the configuration of a communication device 10 having the coil component 100 and an antenna coil 200 for NFC.

FIG. 5 is a schematic view for explaining the configuration of the communication device 10 according to a modification;

FIGS. 6A to 6C are each a schematic view for explaining a difference in size between the coil pattern 120 included in the coil component 100 and the antenna coil 200;

FIGS. 7A and 7B are each a schematic view for explaining a difference in shape between the coil pattern 120 included in the coil component 100 and the antenna coil 200;

FIG. 8 is a schematic view for explaining a difference in a coil axis between the coil pattern 120 included in the coil component 100 and the antenna coil 200;

FIG. 9 is a schematic plan view illustrating the shape of the conductor pattern formed on one surface 31 of the substrate 30;

FIG. 10 is a schematic plan view illustrating the shape of the conductor pattern formed on the other surface 32 of the substrate 30;

FIG. 11 is a schematic plan view illustrating an overlapping state between the coil patterns CP1, CP3 and the coil patterns CP2, CP4 as viewed from the surface 31 side of the substrate 30;

FIG. 12 is a schematic view illustrating a state where the communication device 10 is accommodated in a housing 500; and

FIG. 13 is a schematic diagram showing a state in which the antenna coil 200 is accommodated in a housing 500 and the coil component 100 is disposed outside the housing 500.

### DETAILED DESCRIPTION OF THE EMBODIMENTS

The present disclosure describes a technology for satisfying both the electrical and physical characteristics of a coil component having a coil conductor at least partially embedded in a resin layer.

Some embodiments of the present disclosure will be explained below in detail with reference to the accompanying drawings.

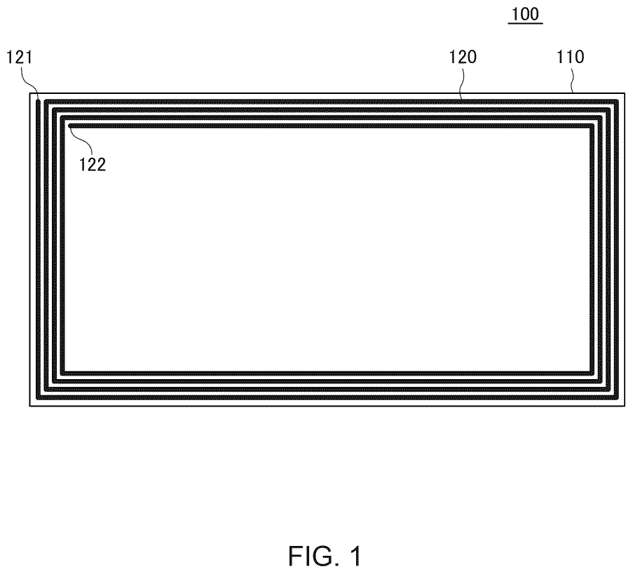

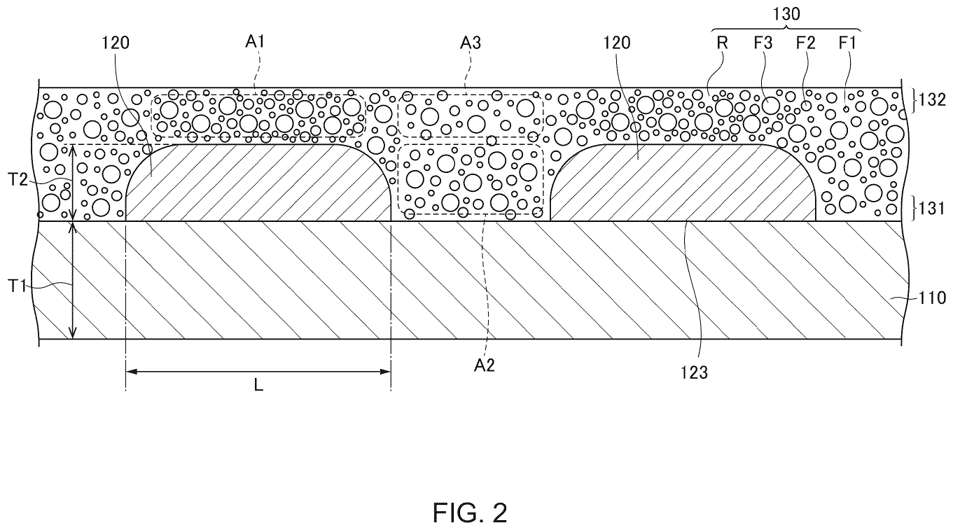

FIG. 1 is a schematic plan view illustrating the outer appearance of a coil component 100 according to an embodiment of the present disclosure. FIG. 2 is a schematic partial cross-sectional view of the coil component 100.

As illustrated in FIGS. 1 and 2, the coil component 100 according to the present embodiment includes a substrate 110, a coil pattern 120 provided on the surface of the substrate 110, and a resin layer 130 provided on the surface of the substrate 110 so as to embed therein at least a part of the coil pattern 120. As the substrate 110, an insulating film of PET (Polyethylene Terephthalate) or PI (Polyimide) can be used. The thickness of the substrate 110 is T1.

The coil pattern 120 is a coil conductor wound in a plurality of turns along the outer periphery of the substrate 110. The number of turns of the coil pattern 120 is determined depending on target inductance and capacitance. Outer and inner peripheral ends 121 and 122 of the coil pattern 120 are both opened without being connected to another conductive member. Thus, the coil pattern 120 is in an electrically floating state. The coil pattern 120 is formed by applying electrolytic plating to the surface of the substrate 110, for example. In this case, a lower surface 123 of the coil pattern 120 is in contact with the surface of the substrate 110. The lower surface 123 of the coil pattern 120 may be formed of a seed layer containing resin. The substrate 110 may be removed after formation of the coil pattern 120; however, when the substrate 110 is left without being removed, the lower surface 123 of the coil pattern 120 can be protected. The thickness of the coil pattern 120 is T2, which is smaller than a pattern width L of the coil pattern 120, whereby the coil pattern 120 has a flat shape.

The resin layer 130 contains insulating inorganic fillers F1 to F3 and binder resin R. The resin layer 130 acts to protect the coil pattern 120 and adjust capacitance generated between adjacent turns of the coil pattern 120. The inorganic fillers F1 to F3 all have a spherical shape but have mutually different particle diameters. The inorganic fillers F1 are small-diameter fillers having a first particle diameter distribution whose average value is a first particle diameter. The inorganic fillers F2 are middle-diameter fillers having a second particle diameter distribution whose average value is a second particle diameter larger than the first particle diameter. The inorganic fillers F3 are large-diameter fillers having a third particle diameter distribution whose average value is a third particle diameter larger than the second particle diameter. Using the three inorganic fillers F1 to F3 having different particle diameter distributions increases the filling rate of the inorganic fillers in the resin layer 130.

The material of the inorganic fillers F1 to F3 may be a nonmagnetic inorganic material such as alumina, aluminum hydroxide, talc, magnesium hydroxide, silica, calcium carbonate, barium titanate, zirconium titanate, or zinc zirconate titanate, or a magnetic material such as a ferrite or an Fe-based alloy magnetic body. The materials of the inorganic fillers F1 to F3 may be the same, or some of the materials thereof may be different. The dielectric constant of the inorganic fillers F1 to F3 may be higher than that of the binder resin R.

Examples of the material of the binder resin R1 include acrylic resin, polyester resin, polyethylene resin, polyvinyl chloride resin, polyvinyl butyral resin, poly urethane resin, polyester urethane resin, cellulose resin, ABS (acrylonitrile-butadiene-styrene) resin, nitrile-butadiene rubber, styrene-butadiene rubber, epoxy resin, phenol resin, amide resin, polyester elastomer, and polyamide elastomer.

As illustrated in FIG. 2, the resin layer 130 includes an area A1 that overlaps the coil pattern 120 in the stacking direction (coil axis direction), an area A2 positioned between adjacent turns of the coil pattern 120, and an area A3 that overlaps the area A2 in the stacking direction. The area A2 does not overlap the coil pattern 120 in the stacking direction and is positioned within the height range of the coil pattern 120. The area A3 does not overlap the coil pattern 120 in the stacking direction and is positioned above the height position of the coil pattern 120.

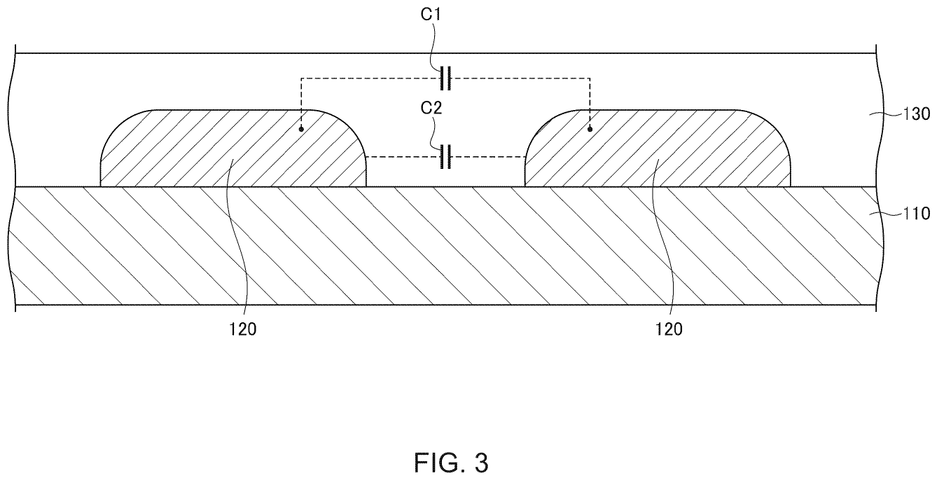

The filling rate of the inorganic fillers F1 to F3 in the resin layer 130 may be higher in the area A1 than in the area A2. Thus, when a material having a dielectric constant higher than that of the binder resin R is used as the material of the inorganic fillers F1 to F3, the dielectric constant in the area A1 is enhanced. As a result, the capacitance of a capacitor C1 generated between adjacent turns and passing through the area A1 (A3) as illustrated in FIG. 3 is enhanced. On the other hand, the area A2 has a higher proportion of the binder resin R due to its lower filling rate of the inorganic fillers F1 to F3 than the area A1. This improves embedding property between adjacent turns, so that voids are unlikely to occur, and adhesion with respect to the coil pattern 120 is enhanced. With such a mechanism, it is possible to satisfy both the electrical and physical characteristics of the coil component 100. Further, in the present embodiment, the coil pattern 120 has a flat shape in which the thickness T2 is smaller than the pattern width L, so that the capacitance of a capacitor C2 that passes through the area A2 becomes smaller than that of the capacitor C1 that passes through the area A1. That is, the capacitance of the capacitor C1 becomes dominant in between adjacent turns. Further, since the dielectric constant in the area A1 is enhanced, the capacitance occurring between adjacent turns is effectively enhanced.

Further, the resin layer 130 includes a surface layer 131 on one side thereof in the thickness direction which contacts the substrate 110 and in which the coil pattern 120 is present and a surface layer 132 positioned on the other side thereof, in which the coil pattern 120 is absent. The filling rate of the inorganic fillers F1 to F3 in the resin layer 130 may be higher in the surface layer 132 than in the surface layer 131. This further enhances the capacitance of the capacitor C1 that passes through the areas A1 and A3. In addition, the shape retainability of resin layer 130 is improved to enhance the flatness of the coil component 100.

The ratio of the inorganic fillers F3 in the resin layer 130 may be higher in the area A2 than in the area A3. This enhances the capacitance of the capacitor C2 that passes through the area A2. Similarly, the ratio of the inorganic fillers F2 in the resin layer 130 may be higher in the area A2 than in the area A3. Further, as illustrated in FIG. 2, the thickness T2 of the coil pattern 120 may be smaller than the thickness T1 of the substrate 110. This can reduce the entire thickness of the coil component 100 and makes more dominant the capacitance of the capacitor C1 that passes through the area A1.

The coil component 100 according to the present embodiment is disposed so as to overlap an antenna coil for near field communication (NFC) to thereby function as a booster coil for increasing communication distance.

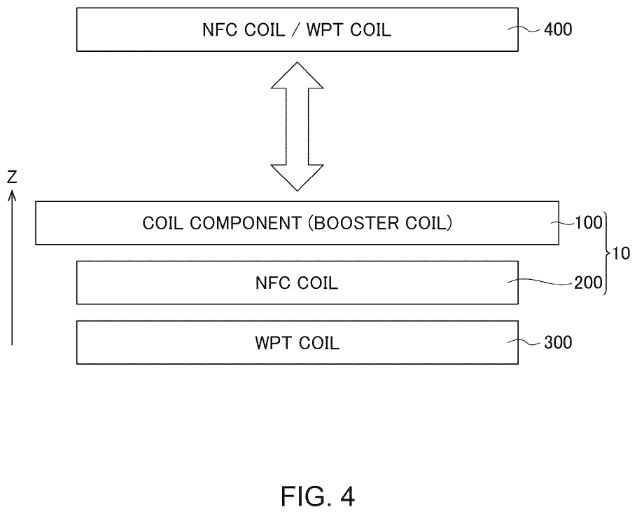

FIG. 4 is a schematic view for explaining the configuration of a communication device 10 having the coil component 100 and an antenna coil 200 for NFC.

The antenna coil 200 illustrated in FIG. 4 has a coil axis extending in the Z-direction and is put over a wireless device 400 as a communication target in the Z-direction. The wireless device 400 also includes an antenna coil for NFC, and when the antenna coil 200 and wireless device 400 are put one over the other in the Z-direction, communication therebetween is established. In addition, when the coil component 100 according to the present embodiment is provided between the antenna coil 200 and the wireless device 400, it functions as a booster coil to thereby increase communication distance. In the example illustrated in FIG. 4, the coil component 100 and antenna coil 200 may be fixed to each other through an adhesive sheet or may be arranged so as to be spaced apart from each other with a space.

In the example illustrated in FIG. 4, a power transmitting coil 300 for wireless power transmission is disposed on a side opposite to the coil component 100 with respect to the antenna coil 200. The wireless device 400 includes a power receiving coil for wireless power transmission, and when the power transmitting coil 300 and wireless device 400 are put one over the other in the Z-direction, power is wirelessly transmitted from the power transmitting coil 300 to the wireless device 400.

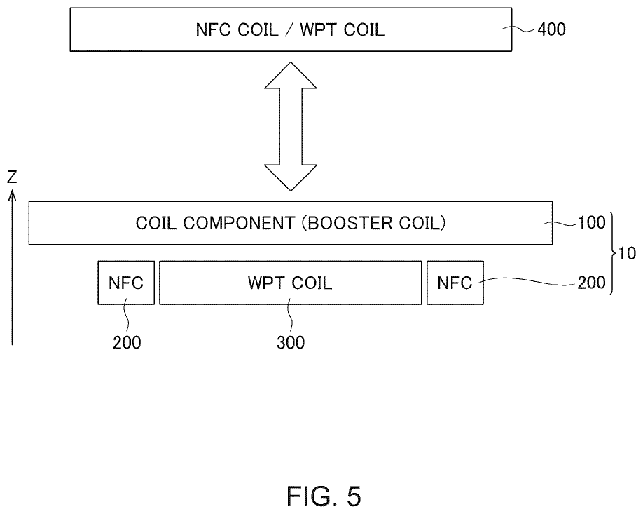

FIG. 5 is a schematic view for explaining the configuration of the communication device 10 according to a modification.

In the example illustrated in FIG. 5, the antenna coil 200 and the power transmitting coil 300 are disposed at the same position in the Z-direction in such a manner that the antenna coil 200 surrounds the power transmitting coil 300. The antenna coil 200 and power transmitting coil 300 may thus be coaxially arranged. In the example illustrated in FIG. 5, the coil component 100 and antenna and power transmitting coils 200 and 300 may be fixed to each other through an adhesive sheet or may be arranged so as to be spaced apart from each.

In the example illustrated in FIGS. 4 and 5, the planar size of the coil pattern 120 included in the coil component 100 is larger than that of the antenna coil 200. By thus making the planar size of the coil pattern 120 larger than that of the antenna coil 200, planar communicable area is enlarged.

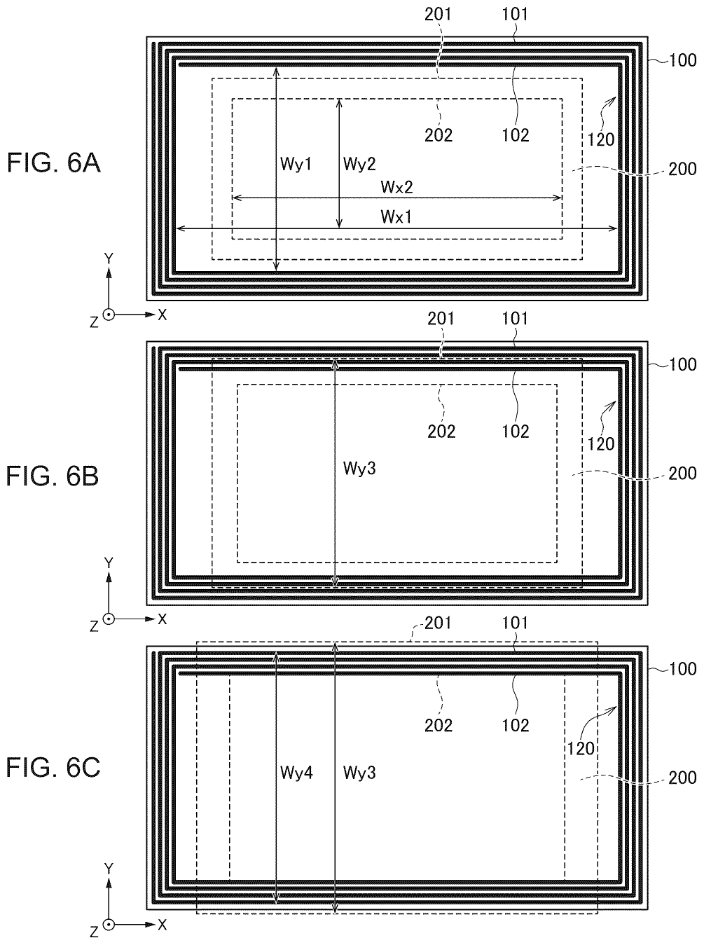

FIGS. 6A to 6C are each a schematic view for explaining a difference in size between the coil pattern 120 included in the coil component 100 and the antenna coil 200.

In the example illustrated in FIG. 6A, the antenna coil 200 is disposed at a position overlapping the opening area of the coil pattern 120. The inner size of the coil pattern 120 is defined by an area surrounded by an innermost turn 102 of the coil pattern 120, and the planar size of the coil pattern 120 is defined by an area surrounded by an outermost turn 101 of the coil pattern 120. Similarly, the inner size of the antenna coil 200 is defined by an area surrounded by an innermost turn 202 of the antenna coil 200, and the planar size of the antenna coil 200 is defined by an area surrounded by an outermost turn 201 of the antenna coil 200. In the example illustrated in FIG. 6A, the outermost turn 201 of the antenna coil 200 is positioned within the innermost turn 102 of the coil pattern 120.

In the example illustrated in FIG. 6A, both the coil pattern 120 and antenna coil 200 have a planer shape having a longer side in the X-direction and a shorter side in Y-direction perpendicular to the X-direction. The inner size of the coil pattern 120 in the X-direction is Wx1, and the inner size of the antenna coil 200 in the X-direction is Wx2 (<Wx1). The inner size of the coil pattern 120 in the Y-direction is Wy1, and the inner size of the antenna coil 200 in the Y-direction is Wy2 (<Wy1). The difference (=Wx1−Wx2) between the inner sizes of the coil pattern 120 and antenna coil 200 in the X-direction is larger than the difference (=Wy1-Wy2) between the inner sizes of the coil pattern 120 and antenna coil 200 in the Y-direction. As a result, planar communicable area is enlarged in X- and Y-directions (enlarged more in the X-direction than in the Y-direction). For example, in a mobile terminal such as a smartphone, there may be cases where the wireless device 400 is disposed at the center of the mobile terminal and where it is disposed at an end portion of the mobile terminal in the X-direction, so that by significantly further enlarging the planar communicable area in the X-direction, satisfactory communication can be achieved with respect to mobile terminals of any type.

In the example illustrated in FIG. 6B, an outer size Wy3 of the antenna coil 200 in the Y-direction is larger than the inner size Wy1 of the coil pattern 120 in the Y-direction, and thus the coil pattern 120 and antenna coil 200 partially overlap each other in a plan view. Also in the example illustrated in FIG. 6B, the inner size Wx1 of the coil pattern 120 in the X-direction is larger than the inner size Wx2 of the antenna coil 200 in the X-direction, and the inner size Wy1 of the coil pattern 120 in the Y-direction is larger than the inner size Wy2 of the antenna coil 200 in the Y-direction. Further, the difference (=Wx1−Wx2) between the inner sizes of the coil pattern 120 and antenna coil 200 in the X-direction is larger than the difference (=Wy1−Wy2) between the inner sizes of the coil pattern 120 and antenna coil 200 in the Y-direction. As described above, the coil pattern 120 and antenna coil 200 may partially overlap each other.

In the example illustrated in FIG. 6C, the outer size Wy3 of the antenna coil 200 in the Y-direction is larger than an outer size Wy4 of the coil pattern 120 in the Y-direction. Accordingly, the coil pattern 120 and antenna coil 200 partially overlap each other in a plan view, and the antenna coil 200 partially protrudes from the coil pattern 120 in the Y-direction in a plan view. In the example illustrated in FIG. 6C, the inner size Wx1 of the coil pattern 120 in the X-direction is larger than the inner size Wx2 of the antenna coil 200 in the X-direction, while the inner size Wy1 of the coil pattern 120 in the Y-direction is almost the same as the inner size Wy2 of the antenna coil 200 in the Y-direction. Further, the difference (=Wx1−Wx2) between the inner sizes of the coil pattern 120 and antenna coil 200 in the X-direction is larger than the difference (=Wy1−Wy2) between the inner sizes of the coil pattern 120 and antenna coil 200 in the Y-direction. As described above, the antenna coil 200 may partially protrude from the coil pattern 120 in a plan view.

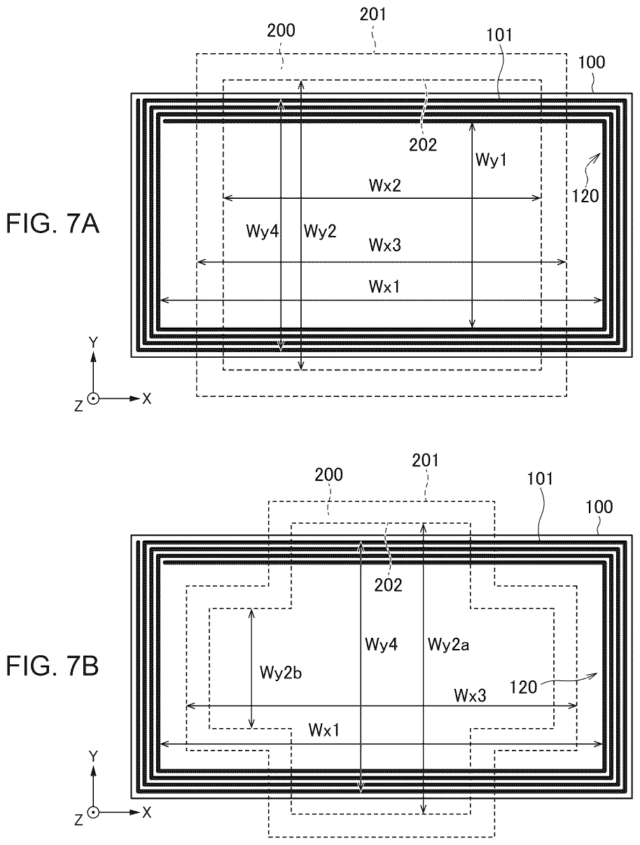

In the example illustrated in FIG. 7A, the inner size Wy2 of the antenna coil 200 in the Y-direction is larger than the outer size Wy4 of the coil pattern 120 in the Y-direction, and thus, the opening area of the antenna coil 200 is partially positioned outside the coil pattern 120 in a plan view. The outer size Wx3 of the antenna coil 200 in the X-direction is smaller than the inner size Wx1 of the coil pattern 120 in the X-direction. In this case, the absolute value (=|Wx1−Wx2|) of the difference between the inner sizes of the coil pattern 120 and antenna coil 200 in the X-direction may be larger than the absolute value (=|Wy1−Wy2|) of the difference between the inner sizes of the coil pattern 120 and antenna coil 200 in the Y-direction. As described above, the opening area of the antenna coil 200 may be partially positioned outside the coil pattern 120. Even in this case, the planar size of the coil pattern 120 may be larger than that of the antenna coil 200.

In the example illustrated in FIG. 7B, an inner size Wy2a in the Y-direction at the center portion in the X-direction of the antenna coil 200 is larger than an inner size Wy2b in the Y-direction at both end portions in the X-direction of the antenna coil 200. Further, the inner size Wy2a in the Y-direction at the center portion in the X-direction of the antenna coil 200 is larger than the outer size Wy4 of the coil pattern 120 in the Y-direction. As a result, the opening area of the antenna coil 200 is partially positioned outside the coil pattern 120. The outer size Wx3 of the antenna coil 200 in the X-direction is smaller than the inner size Wx1 of the coil pattern 120 in the X-direction. As describe above, the size of the antenna coil 200 in the Y-direction may differ depending on its position in the X-direction.

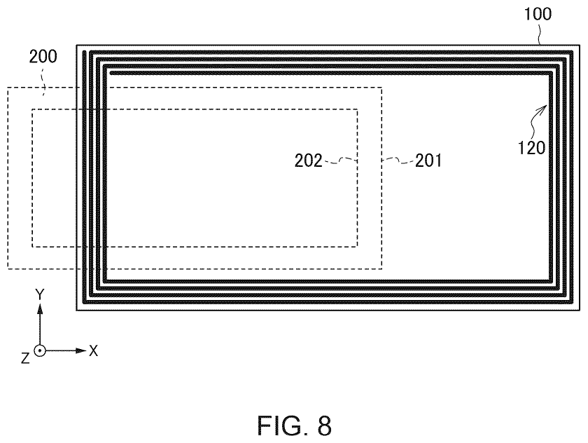

In the example illustrated in FIG. 8, the center axis of the antenna coil 200 is offset from the center axis of the coil pattern 120 in the X-direction, and thus the antenna coil 200 partially protrudes from the coil pattern 120 in the X-direction. When the center axes of the antenna coil 200 and coil pattern 120 are thus offset from each other, the coupling coefficient therebetween can be adjusted.

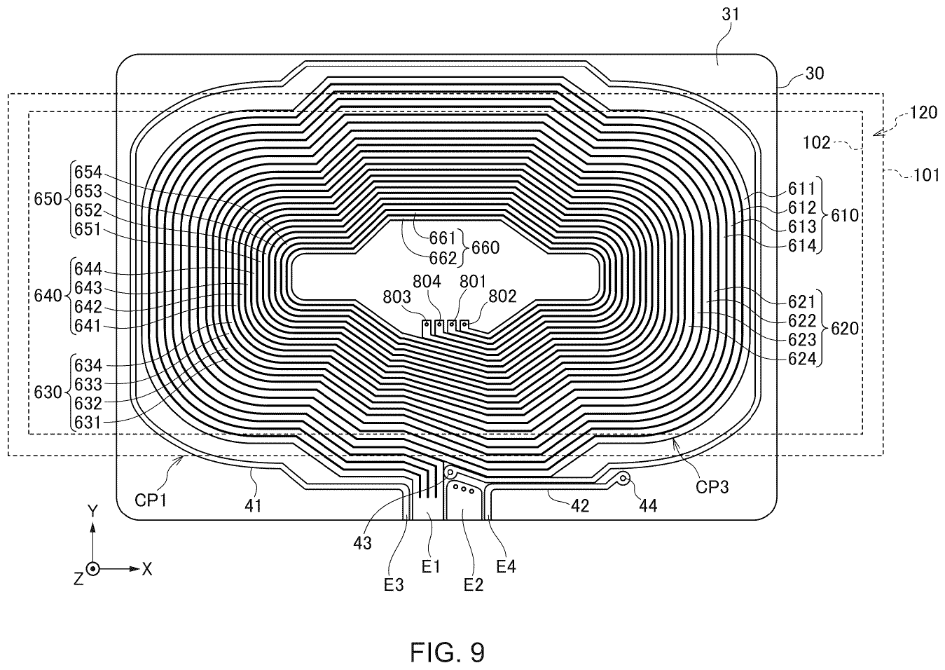

FIGS. 9 to 11 are schematic plan views for explaining more specifically the configuration of the communication device 10 according to the modification illustrated in FIG. 5. In the example illustrated in FIGS. 9 to 11, the antenna coil 200 and power transmitting coil 300 are provided on the surface of the same substrate 30. Further, in FIGS. 9 to 11, the planar position of the coil pattern 120 is denoted by dashed lines.

FIG. 9 is a schematic plan view illustrating the shape of the conductor pattern formed on one surface 31 of the substrate 30.

As illustrated in FIG. 9, there are formed, on the surface 31 of the substrate 30, a coil pattern CP1 constituting a part of the antenna coil 200, a coil pattern CP3 constituting a part of the power transmitting coil 300, and terminal electrodes E1 to E4.

The coil pattern CP3 has a six-turn configuration constituted of turns 610, 620, 630, 640, 650, and 660. The turn 610 is positioned at the outermost periphery, and the turn 660 is positioned at the innermost periphery. The turns 610, 620, 630, 640, and 650 are each radially divided into four lines by three spiral slits. The turn 660 is radially divided into two lines by one spiral slit. As a result, the turn 610 is divided into four lines 611 to 614, the turn 620 is divided into four lines 621 to 624, the turn 630 is divided into four lines 631 to 634, the turn 640 is divided into four lines 641 to 644, the turn 650 is divided into four lines 651 to 654, and the turn 660 is divided into two lines 661 and 662.

The lines 611, 621, 631, 641, 651, and 661 constitute a continuous line spirally wound in six turns and are each positioned at the outermost periphery in its corresponding turn. The lines 612, 622, 632, 642, 652, and 662 constitute a continuous line spirally wound in six turns and are each the second line counted from the outermost peripheral line in its corresponding turn. The lines 613, 623, 633, 643, and 653 constitute a continuous line spirally wound in five turns and are each the second line counted from the innermost peripheral line in its corresponding turn. The lines 614, 624, 634, 644, and 654 constitute a continuous line spirally wound in five turns and are each positioned at the innermost periphery in its corresponding turn.

The outer peripheral ends of the lines 611 to 614 are connected in common to the terminal electrode E1. The inner peripheral ends of the lines 661, 662, 653, and 654 are connected respectively to through hole conductors 801, 802, 803, and 804 penetrating the substrate 30.

The coil pattern CP1 includes a conductor pattern 41 disposed outside the coil pattern CP3 so as to surround the same and a conductor pattern 42 disposed outside the coil pattern CP3 separately from the conductor pattern 41. The conductor pattern 41 is a continuous line wound in about one turn, and the coil pattern CP3 is disposed within the opening area (inner diameter area) thereof. One end of the conductor pattern 41 is connected to the terminal electrode E3, and the other end thereof is connected to a through hole conductor 43 penetrating the substrate 30. One end of the conductor pattern 42 is connected to the terminal electrode E4, and the other end thereof is connected to a through hole conductor 44 penetrating the substrate 30.

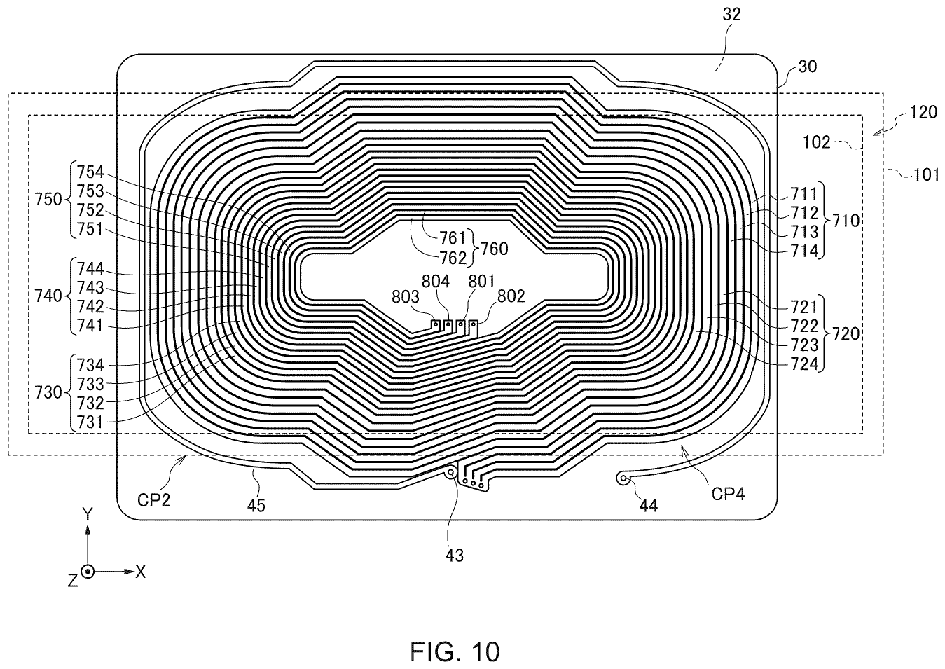

FIG. 10 is a schematic plan view illustrating the shape of the conductor pattern formed on the other surface 32 of the substrate 30, which illustrates a state viewed from the surface 31 side of the substrate 30 transparently through the substrate 30.

As illustrated in FIG. 10, there are formed, on the surface 32 of the substrate 30, a coil pattern CP2 constituting the remaining part of the antenna coil 200 and a coil pattern CP4 constituting the remaining part of the power transmitting coil 300.

The coil pattern CP4 has the same pattern shape as that of the coil pattern CP3. The coil pattern CP4 has a six-turn configuration constituted of turns 710, 720, 730, 740, 750, and 760. The turn 710 is positioned at the outermost periphery, and the turn 760 is positioned at the innermost periphery. The turns 710, 720, 730, 740, and 750 are each radially divided into four lines by three spiral slits. The turn 760 is radially divided into two lines by one spiral slit. As a result, the turn 710 is divided into four lines 711 to 714, the turn 720 is divided into four lines 721 to 724, the turn 730 is divided into four lines 731 to 734, the turn 740 is divided into four lines 741 to 744, the turn 750 is divided into four lines 751 to 754, and the turn 760 is divided into two lines 761 and 762.

The lines 711, 721, 731, 741, 751, and 761 constitute a continuous line spirally wound in six turns and are each positioned at the outermost periphery in its corresponding turn. The lines 712, 722, 732, 742, 752, and 762 constitute a continuous line spirally wound in six turns and are each the second line counted from the outermost peripheral line in its corresponding turn. The lines 713, 723, 733, 743, and 753 constitute a continuous line spirally wound in five turns and are each the second line counted from the innermost peripheral line in its corresponding turn. The lines 714, 724, 734, 744, and 754 constitute a continuous line spirally wound in five turns and are each positioned at the innermost periphery in its corresponding turn.

The outer peripheral ends of the lines 711 to 714 are connected in common to the terminal electrode E2 through through hole conductors. The inner peripheral ends of the lines 761, 762, 753, and 754 are connected respectively to through hole conductors 804, 803, 802, and 801. As a result, the power transmitting coil 300 having a configuration in which four lines each wound in 11 turns are connected in parallel is connected between the terminal electrodes E1 and E2.

The conductor pattern 45 constituting the coil pattern CP2 is a continuous line wound in about one turn and is disposed outside the coil pattern CP4 in such a manner as to surround the same. That is, the coil pattern CP4 is disposed within the opening area (inner diameter area) of the conductor pattern 45 constituting the coil pattern CP2. One end and the other end of the conductor pattern 45 are connected respectively to the through hole conductors 43 and 44. As a result, the total number of turns of the antenna coil 200 constituted of the coil patterns CP1 and CP2 is about two turns.

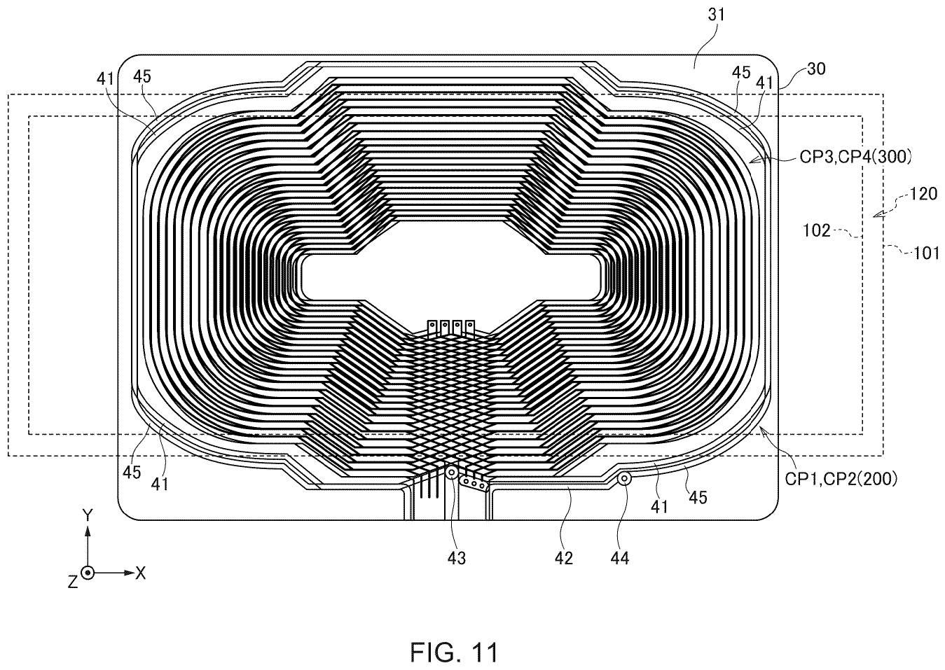

FIG. 11 is a schematic plan view illustrating an overlapping state between the coil patterns CP1, CP3 and the coil patterns CP2, CP4 as viewed from the surface 31 side of the substrate 30.

As illustrated in FIG. 11, in a state where the substrate 30 on which antenna coil 200 and power transmitting coil 300 are formed and the coil pattern 120 are put one over the other, the inner size of the antenna coil 200 (CP1, CP2) in the Y-direction is partially larger and partially smaller than the outer size of the coil pattern 120 in the Y-direction as in the example illustrated in FIG. 7B. Thus, sections of the conductor patterns 41, 42, and 45 of the antenna coil 200 (CP1, CP2) that extend in the X-direction each have portions positioned inside and outside the coil pattern 120, and the outer size of the antenna coil (CP1, CP2) in the X-direction is smaller than the inner size of the coil pattern 120 in the X-direction, with the result that sections of the conductor patterns 41, 42, and 45 of the antenna coil 200 (CP1, CP2) that extend in the Y-direction are positioned inside the coil pattern 120.

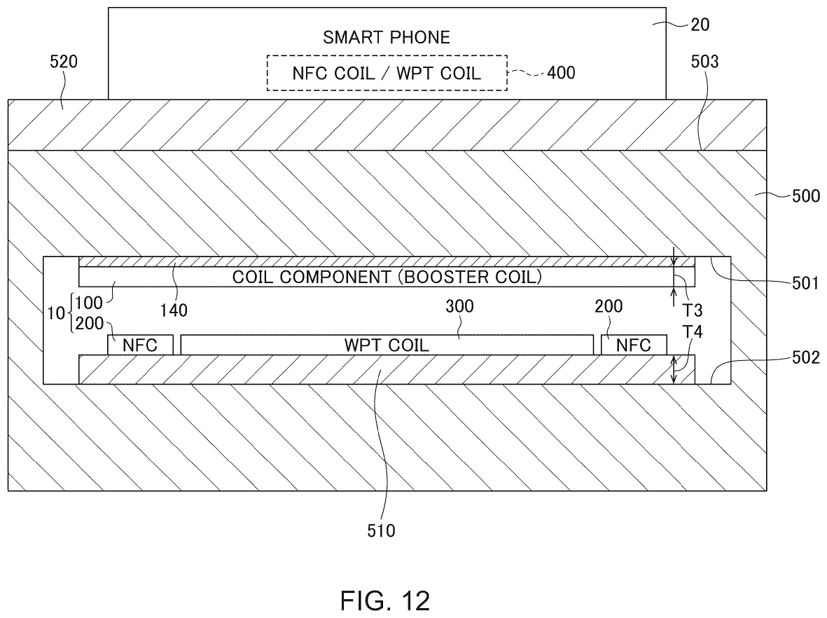

FIG. 12 is a schematic view illustrating a state where the communication device 10 is accommodated in a housing 500.

In the example illustrated in FIG. 12, the housing 500 has inner surfaces 501 and 502 facing each other. The coil component 100 is bonded to the inner surface 501 through an adhesive layer 140, and a circuit board 510 having thereon the antenna coil 200 and power transmitting coil 300 is placed on the inner surface 502. The adhesive layer 140 may bond the resin layer 130 of the coil component 100 and the inner surface 501 of the housing 500. In the example illustrated in FIG. 12, the antenna coil 200 and power transmitting coil 300 are each a pattern coil constituted by a conductor pattern formed on the circuit board 510 and are integral with the circuit board 510. A thickness T3 of the coil component 100 may be smaller than a thickness T4 of the circuit board 510, which allows the coil component 100 to be accommodated in the internal space of the housing 500 even when the internal space has a low profile.

The housing 500 has an outer surface 503 positioned opposite to the inner surface 501. The outer surface 503 is covered with a rubber mat 520, on which a smartphone 20 or the like can be placed. The rubber mat 520 acts to prevent damage to the smartphone 20 and to reduce sliding of the smartphone 20. Upon placement of the smartphone 20 on the rubber mat 520, communication can be established between the wireless device 400 included in the smartphone 20 and the antenna coil 200, and power can be transmitted from the power transmitting coil 300 to the wireless device 400. Since the coil component 100 according to the present embodiment is disposed between the wireless device 400 and the antenna coil 200, communication between the wireless device 400 and the antenna coil 200 can be performed more efficiently. In particular, as described using FIGS. 6A to 6C, 7A, 7B, and 8, when the planar size of the coil pattern 120 included in the coil component 100 is made larger than that of the antenna coil 200, planar communicable area is enlarged, so that even if the planar position of the smartphone 20 placed on the rubber mat 520 is shifted from the center position of the antenna coil 200, communication can be established.

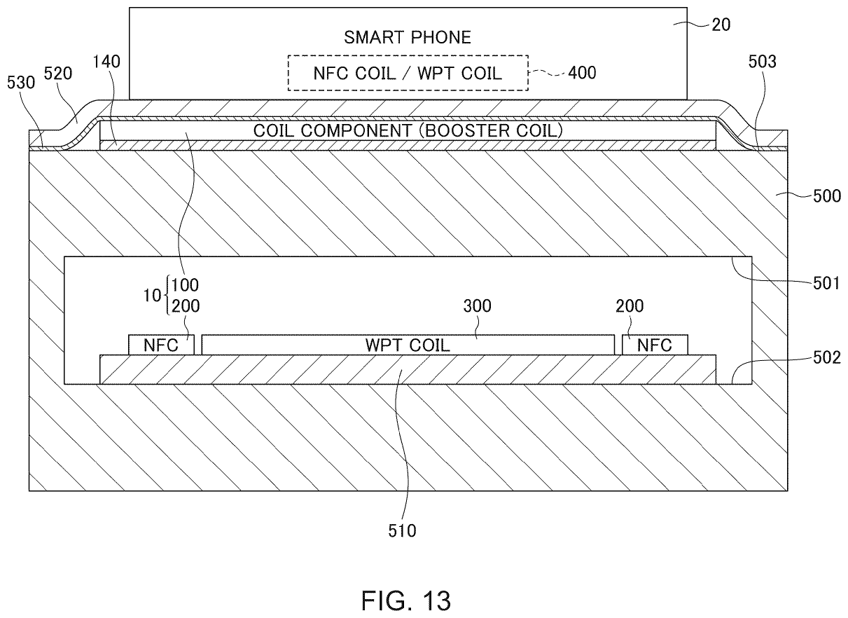

In the example illustrated in FIG. 12, both the coil component 100 and antenna coil 200 are accommodated in the housing 500; however, as illustrated in the modification illustrated in FIG. 13, a configuration is possible in which the circuit board 510 having thereon the antenna coil 200 and power transmitting coil 300 is accommodated in the housing 500, and the coil component 100 is disposed on the outer surface 503 of the housing 500. In this case, the coil component 100 is disposed between the outer surface 503 of the housing 500 and the rubber mat 520 with an adhesive layer 530 interposed between itself and the rubber mat 520.

While the some embodiments of the present disclosure has been described, the present disclosure is not limited to the above embodiment, and various modifications may be made within the scope of the present disclosure, and all such modifications are included in the present disclosure.

For example, although the coil component 100 according to the above embodiment is configured by using the coil pattern 120 having a conductor pattern wound on the surface of the substrate 110, it is not necessarily configured of the pattern coil, and instead a coil conductor formed of a spirally wound coated conductive wire may be used. Similarly, the configurations of the antenna coil 200 and power transmitting coil 300 are not limited to the pattern coil, and a coil conductor formed of a spirally wound insulating coated conductive wire may be used.

The technology according to the present disclosure includes the following configuration examples but not limited thereto.

A coil component according to an embodiment of the present disclosure includes: a resin layer containing insulating inorganic fillers and binder resin; and a coil conductor embedded at least partially in the resin layer and wound in a plurality of turns. The resin layer includes a first area that overlaps the coil conductor as viewed in the coil axis direction and a second area positioned between adjacent turns of the coil conductor, and the filling rate of the inorganic fillers in the resin layer is higher in the first area than in the second area. This can satisfy both electrical and physical characteristics.

In the above coil component, the resin layer may include a first surface layer on one side thereof in the thickness direction, in which the coil conductor is present and a second surface layer positioned on the other side thereof, in which the coil conductor is absent. The filling rate of the inorganic fillers in the resin layer may be higher in the second surface layer than in the first surface layer. This can increase the strength of the second surface layer.

In the above coil component, the inorganic fillers may include first inorganic fillers having a first particle diameter distribution whose average value is a first particle diameter and second inorganic fillers having a second particle diameter distribution whose average value is a second particle diameter larger than the first particle diameter. The resin layer may further include a third area that overlaps the second area as viewed in the coil axis direction, and the ratio of the second inorganic fillers in the resin layer may be higher in the second area than in the third area. This can enhance the capacitance of the coil pattern.

The above coil component may further include a substrate on which the coil conductor is formed, the coil conductor may be constituted by a coil pattern formed of a wound conductor pattern, and the thickness of the coil pattern may be smaller than that of the substrate. This can reduce the entire thickness.

In the above coil component, both ends of the coil conductor may be opened. This facilitates the manufacturing of the coil component.

In the above coil component, the dielectric constant of the inorganic fillers may be higher than that of the binder resin. This can achieve larger capacitance.

A communication device according to an embodiment of the present disclosure includes: an antenna coil; and the above-described coil component disposed so as to overlap the antenna coil. Thus, the coil component functions as a booster coil for the antenna coil.

In the above communication device, the planar size of the coil conductor included in the coil component may be larger than that of the antenna coil. This can enlarge planar communicable area.

In the above communication device, the coil conductor and antenna coil may each have a planar shape having a longer side in a first direction and a shorter side in a second direction perpendicular to the first direction, and the difference between the inner sizes of the coil conductor and antenna coil in the first direction may be larger than the difference between the inner sizes of the coil conductor and antenna coil in the second direction. This can enlarge planar communicable area more in the first direction.

In the above communication device, the coil conductor and antenna coil may each have a planar shape having a longer side in a first direction and a shorter side in a second direction perpendicular to the first direction, the outer size of the coil conductor in the first direction may be larger than that of the antenna coil in the first direction, and the inner size of the antenna coil in the second direction may be larger than the outer size of the coil conductor in the second direction. This can enlarge planar communicable area more in the first direction.

In the above communication device, the coil conductor and antenna coil may each have a planar shape having a longer side in a first direction and a shorter side in a second direction perpendicular to the first direction, the outer size of the coil conductor in the first direction may be larger than that of the antenna coil in the first direction, and the outermost turn of the antenna coil in the second direction may have a portion positioned outside the outermost turn of the coil conductor in the second direction and a portion positioned inside the innermost turn of the coil conductor in the second direction. This can enlarge planar communicable area more in the first direction.

In the above communication device, the antenna coil may be formed on a circuit board, and the thickness of the coil component may be smaller than that of the circuit board. This allows the coil component to be disposed in a narrower space.

The above communication device may further include a housing for accommodating therein the coil component and antenna coil, and the coil component may be fixed to the inner surface of the housing. This allows both the coil component and antenna coil to be accommodated in the housing, preventing the outer appearance of the housing from being impaired. Alternatively, the above communication device may further include a housing for accommodating therein the antenna coil, and a rubber mat covering the outer surface of the housing, and the coil component may be disposed between the outer surface of the housing and the rubber mat. As a result, the coil component is hidden by the rubber mat, preventing the outer appearance of the communication device from being impaired.

What is claimed is:

1. A coil component comprising:
a resin layer including insulating inorganic fillers and a binder resin; and
a coil conductor embedded at least partially in the resin layer and wound in a plurality of turns,
wherein the resin layer includes a first area that overlaps the coil conductor as viewed in a coil axis direction and a second area positioned between adjacent turns of the coil conductor, and
wherein a filling rate of the inorganic fillers in the resin layer is higher in the first area than in the second area.

2. The coil component as claimed in claim 1,
wherein the resin layer includes:
a first surface layer on one side thereof in a thickness direction, in which the coil conductor is present; and
a second surface layer positioned on another side thereof, in which the coil conductor is absent, and
wherein a filling rate of the inorganic fillers in the resin layer is higher in the second surface layer than in the first surface layer.

3. The coil component as claimed in claim 1,
wherein the inorganic fillers include:
first inorganic fillers having a first particle diameter distribution whose average value is a first particle diameter; and
second inorganic fillers having a second particle diameter distribution whose average value is a second particle diameter larger than the first particle diameter,
wherein the resin layer further includes a third area that overlaps the second area as viewed in the coil axis direction, and
wherein a ratio of the second inorganic fillers in the resin layer is higher in the second area than in the third area.

4. The coil component as claimed in claim 1, further comprising a substrate on which the coil conductor is formed,
wherein the coil conductor is constituted by a coil pattern formed of a wound conductor pattern, and
wherein a thickness of the coil pattern is smaller than a thickness of the substrate.

5. The coil component as claimed in claim 1, wherein both ends of the coil conductor are opened.

6. The coil component as claimed in claim 1, wherein a dielectric constant of the inorganic fillers is higher than a dielectric constant of the binder resin.

7. A communication device comprising:
an antenna coil; and
a coil component disposed so as to overlap the antenna coil,
wherein the coil component comprises:
a resin layer including insulating inorganic fillers and a binder resin; and
a coil conductor embedded at least partially in the resin layer and wound in a plurality of turns,
wherein the resin layer includes a first area that overlaps the coil conductor as viewed in a coil axis direction and a second area positioned between adjacent turns of the coil conductor, and
wherein a filling rate of the inorganic fillers in the resin layer is higher in the first area than in the second area.

8. The communication device as claimed in claim 7, wherein a planar size of the coil conductor included in the coil component is larger than a planar size of the antenna coil.

9. The communication device as claimed in claim 8,
wherein each of the coil conductor and antenna coil has a planar shape having a longer side in a first direction and a shorter side in a second direction perpendicular to the first direction, and
wherein a difference between an inner sizes of the coil conductor and antenna coil in the first direction is larger than a difference between an inner sizes of the coil conductor and antenna coil in the second direction.

10. The communication device as claimed in claim 8,
wherein each of the coil conductor and antenna coil has a planar shape having a longer side in a first direction and a shorter side in a second direction perpendicular to the first direction,
wherein an outer size of the coil conductor in the first direction is larger than an outer size of the antenna coil in the first direction, and
wherein an inner size of the antenna coil in the second direction is larger than an outer size of the coil conductor in the second direction.

11. The communication device as claimed in claim 8,
wherein each of the coil conductor and antenna coil has a planar shape having a longer side in a first direction and a shorter side in a second direction perpendicular to the first direction,
wherein an outer size of the coil conductor in the first direction is larger than an outer size of the antenna coil in the first direction, and
wherein an outermost turn of the antenna coil in the second direction has a portion positioned outside an outermost turn of the coil conductor in the second direction and a portion positioned inside an innermost turn of the coil conductor in the second direction.

12. The communication device as claimed in claim 7,
wherein the antenna coil is formed on a circuit board, and
wherein a thickness of the coil component is smaller than a thickness of the circuit board.

13. The communication device as claimed in claim 7, further comprising a housing for accommodating therein the coil component and antenna coil,
wherein the coil component is fixed to an inner surface of the housing.

14. The communication device as claimed in claim 7, further comprising:
a housing for accommodating therein the antenna coil; and
a rubber mat covering an outer surface of the housing,
wherein the coil component is disposed between the outer surface of the housing and the rubber mat.
